(19) United States
(12) Patent Application Publication
(10) Pub. No.: US 2023/0373862 A1
(43) Pub. Date: Nov. 23, 2023

(54) ZIRCONIA TOUGHENED ALUMINA CERAMIC SINTERED BODIES

(71) Applicant: Heraeus Conamic North America LLC, CHANDLER, AZ (US)

(72) Inventors: Luke WALKER, Chandler, AZ (US); Matthew Joseph DONELON, Chandler, AZ (US)

(21) Appl. No.: 18/248,632

(22) PCT Filed: Oct. 14, 2021
(86) PCT No.: PCT/US2021/054947

§ 371 Date: Apr. 11, 2023

Related U.S. Application Data
(60) Provisional application No. 63/092,181, filed on Oct. 15, 2020.

(51) Int. Cl. C04B 35/106; C04B 35/626; C04B 38/00

(52) U.S. Cl. CPC C04B 35/106; C04B 35/62645; C04B 38/0051; C04B 2235/3217; C04B 2235/3244; C04B 2235/9607; C04B 2235/775

(57) ABSTRACT

A sintered ceramic body having at least one surface, the sintered ceramic body having a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size of from 0.1 to 5 μm as measured by SEM, wherein sintered ceramic body exhibits a coefficient of thermal expansion of from 6.899 to 9.630×10⁶/° C. across a temperature range of from 25-200° C. to 25-1400° C. as measured in accordance with ASTM E228-17, wherein the sintered ceramic body has a relative density of from 99% to 100% and has a density variation of from 0.2 to less than 5% across a greatest dimension.

### TECHNICAL FIELD

The present disclosure relates to sintered ceramic compositions comprising alumina and zirconia that exhibit high strength and low loss of RF transmission when used as a component of a semiconductor processing tool. These may be components such as chamber liners, RF or microwave transparent windows, showerheads, focus rings, wafer chucks, gas injectors or nozzles, shield rings, clamping rings, mixing manifolds, and gas distribution assemblies. The present disclosure also relates to a method of preparing the sintered ceramic compositions.

### BACKGROUND

Alumina-based sintered objects are excellent in terms of heat resistance, chemical resistance, plasma resistance and thermal conductivity and have a small dielectric loss tangent (tan 6) in a high-frequency region. Alumina-based sintered objects are hence used, for example, as members for use in plasma treatment devices, etchers for semiconductor/liquid-crystal display device production, CVD devices, etc., or as the substrates of plasma-resistant members which are to be coated.

Various proposals have been made in order to improve the corrosion resistance and dielectric loss tangent (dielectric loss) of the alumina-based sintered objects but there is still a need in the art for an alumina-based sintered object that has both corrosion resistance, high thermal conductivity and low-dielectric-loss characteristics and is suitable for use as a substrate on which a dense film can be evenly deposited. There is also a need in the art for an alumina-based sintered object that meets these performance requirements but is also large enough to fabricate components of large dimension such as, for example, between 200 and over 600 mm in the largest dimension.

### BRIEF SUMMARY

These and other needs are addressed by the various embodiments, aspects and configurations as disclosed herein:

Embodiment 1. A sintered ceramic body having at least one surface, the sintered ceramic body comprising: a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size of from 0.1 to 5 μm as measured by SEM, wherein sintered ceramic body exhibits a coefficient of thermal expansion of from 6.899 to 9.630×10⁻⁶/° C. across a temperature range of from 25-200° C. to 25-1400° C. as measured in accordance with ASTM E228-17, wherein the sintered ceramic body has a relative density of from 99% to 100% and has a density variation of from 0.2 to less than 5% across a greatest dimension, wherein the greatest dimension is from 200 to 625 mm, and wherein Si is either not present in the sintered ceramic body or it is present in the sintered ceramic body in an amount of 100 ppm or less.

Embodiment 2. The sintered ceramic body of embodiment 1 wherein the second crystalline phase is present in an amount of from 12 to 25%.

Embodiment 3. The sintered ceramic body as in any one of the preceding embodiments wherein the second crystalline phase is present in an amount of from 5 to 15% by volume of the sintered ceramic body.

Embodiment 4. The sintered ceramic body as in any one of the preceding embodiments wherein Si is present from 14 to 100 ppm.

Embodiment 5. The sintered ceramic body as in one of embodiments 1-3 wherein

Si, if present, is present at not more than 14 ppm.

Embodiment 6. The sintered ceramic body as in any one of the preceding embodiments having a total impurity content of 50 ppm or less of trace elements Li, Na, Mg, K, Ca, B, P, Fe, Cu, Cr, Zn, In, Sn, and Sb (total) as determined by ICPMS.

Embodiment 7. The sintered ceramic body as in any one of the preceding embodiments having a total impurity content of 15 ppm or less of trace elements Li, Na, Mg, K, Ca, B, P, Fe, Cu, Cr, Zn, In, Sn, and Sb (total) as determined by ICPMS.

Embodiment 8. The sintered ceramic body as in any one of the preceding embodiments, wherein the maximum pore size is from 0.1 to 3 μm as measured by SEM.

Embodiment 9. The sintered ceramic body as in any one of the preceding embodiments, wherein the maximum pore size is from 0.1 to 1 μm as measured by SEM.

Embodiment 10. The sintered ceramic body as in any one of the preceding embodiments, wherein the sintered ceramic body has a relative density of from 99% to 99.99%.

Embodiment 11. The sintered ceramic body as in any one of the preceding embodiments wherein the sintered ceramic body has an arithmetical mean height (Sa) in an unetched area of from 3 to 20 nm.

Embodiment 12. The sintered ceramic body as in any one of the preceding embodiments having a maximum height, Sz, in an unetched area of from 0.05 to 1.5 um according to ISO standard 25178-2-2012, section 4.1.7.

Embodiment 13. The sintered ceramic body as in any one of the preceding embodiments having a coefficient of thermal expansion of from 6.685 to 9.630×10⁻⁶/° C. across a temperature range from 25-200 to 25-1400° C.

Embodiment 14. The sintered ceramic body as in any one of the preceding embodiments having a purity of 99.985% and higher.

Embodiment 15. The sintered ceramic body as in any one of the preceding embodiments having a thermal conductivity at ambient temperature of about 27 W/m K as measured in accordance with ASTM E1461-13.

Embodiment 16. The sintered ceramic body as in any one of the preceding embodiments having a thermal conductivity at 200° C. of about 14 W/m K as measured in accordance with ASTM E1461-13.

Embodiment 17. The sintered ceramic body as in any one of the preceding embodiments wherein the second crystalline phase comprising ZrO₂ is present at from 14 vol. % to 18 vol. % and the coefficient of thermal expansion is from 7.520 to 9.558×10⁻⁶/° C. across a temperature range of from 25-200° C. to 25-1400° C. as measured in accordance with ASTM E228-17.

Embodiment 18. The sintered ceramic body as in any one of the preceding embodiments wherein the second crystalline phase comprising ZrO₂ is present at 16 vol. % and the coefficient of thermal expansion is from 7.711 to 9.558×10⁻⁶/° C. across a temperature range of from 25-200° C. to 25-1400° C. as measured in accordance with ASTM E228-17.

Embodiment 19. A method of making a sintered ceramic body, the method comprising the steps of: a) combining aluminum oxide powder and zirconium oxide powder to make a powder mixture, wherein the aluminum oxide powder and the zirconium oxide powder each has a total impurity content of less than 150 ppm; b) calcining the powder mixture by applying heat to raise the temperature of the powder mixture to a calcination temperature of from 600° C. to 1400° C. and maintaining the calcination temperature for a period of from 4 to 12 hours to perform calcination to form a calcined powder mixture; c) disposing the calcined powder mixture inside a volume defined by a tool set of a sintering apparatus and creating vacuum conditions inside the volume, wherein the tool set comprises a graphite die defining the volume, an inner wall, a first and second openings, and first and second punches operatively coupled with the die, wherein each of the first and second punches have an outer wall defining a diameter that is less than a diameter of the inner wall of the die thereby creating a gap between each of the first and second punches and the inner wall of the die when at least one of the first and second punches moves within the volume of the die, wherein the gap is from 10 μm to 100 μm wide; d) applying a pressure of from 5 MPa to 100 MPa to the calcined powder mixture while heating to a sintering temperature of from 1000 to 1700° C. and performing sintering to form the sintered ceramic body; and e) lowering the temperature of the sintered ceramic body, wherein the sintered ceramic body has at least one surface, the sintered ceramic body comprising: a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size of from 0.1 to 5 μm as measured by SEM, wherein sintered ceramic body exhibits a coefficient of thermal expansion of from 6.899 to 9.630×10⁻⁶/° C. across a temperature range of from 25-200° C. to 25-1400° C. as measured in accordance with ASTM E228-17, wherein the sintered ceramic body has a relative density of from 99% to 100% and has a density variation of from 0.2 to less than 5% across a greatest dimension, wherein the greatest dimension is from 200 to 625 mm, and wherein Si is either not present in the sintered ceramic body or it is present in the sintered ceramic body in an amount of 100 ppm or less.

Embodiment 20. The method according to embodiment 19 wherein the powder mixture of step a) comprises zirconium oxide in an amount such that the sintered ceramic body has from 5 to 25 vol. % of zirconia.

Embodiment 21. The method according to any one of embodiments 19 or 20, further comprising the steps of: 0 annealing the sintered ceramic body by applying heat to raise the temperature of the sintered ceramic body to reach an annealing temperature, performing annealing; and g) lowering the temperature of the annealed sintered ceramic body.

Embodiment 22. The method according as in any one of embodiments 19 to 21 further comprising the step of: h) machining the sintered ceramic body to create a sintered ceramic component in the form of a dielectric window or RF window, a focus ring, a nozzle or a gas injector, a shower head, a gas distribution plate, an etch chamber liner, a plasma source adapter, a gas inlet adapter, a diffuser, an electronic wafer chuck, a chuck, a puck, a mixing manifold, an ion suppressor element, a faceplate, an isolator, a spacer, and/or a protective ring in etch chambers.

Embodiment 23. The method as in any one of embodiments 19 to 22 wherein the sintering temperature is from 1000 to 1300° C.

Embodiment 24. The method as in any one of embodiments 19 to 23 wherein from 5 to 59 MPa of pressure is applied to the calcined powder mixture while heating to the sintering temperature.

Embodiment 25. The method according to embodiment 24 wherein the pressure is from 5 to 40 MPa.

Embodiment 26. The method according to embodiment 25 wherein the pressure is from 5 to 20 MPa.

Embodiment 27. A sintered ceramic body made by the process of any one of embodiments 19 to 26.

The embodiments of the invention can be used alone or in combinations with each other.

### BRIEF DESCRIPTION OF THE DRAWINGS

FIG. 1 is a SEM micrograph at 5000× magnification showing zirconia distributed in an alumina matrix;

FIG. 2 is a plot of the coefficient of thermal expansions comparing compositions having varying amounts of zirconia across a temperature range from 25-200 to 25-1400° C.;

FIG. 3 is a SEM micrograph (5000×) of the surface of the sintered ceramic body of a sintered ceramic body as disclosed herein comprising 16 vol. % ZrO₂;

FIG. 4 is a plot of pore area versus pore size for the surface of a ssintered ceramic body as disclosed herein comprising 16 vol % ZrO₂; and

FIG. 5 is a graph illustrating the XRD pattern of the surface of a sintered ceramic body as disclosed herein comprising 15 vol % of ZrO₂.

FIG. 6 is a graph illustrating the second crystalline phase total area by size and frequency.

### DETAILED DESCRIPTION

Reference will now be made in detail to specific embodiments. Examples of the specific embodiments are illustrated in the accompanying drawings. While the invention will be described in conjunction with these specific implementations, it will be understood that it is not intended to limit the invention to such specific embodiments. On the contrary, it is intended to cover alternatives, modifications, and equivalents as may be included within the spirit and scope as defined by the appended claims. In the following description, numerous specific details are set forth in order to provide a thorough understanding of the disclosed embodiments. The present invention may be practiced without some or all of these specific details.

### Definitions

As used herein, the term “alumina” is understood to be aluminum oxide, comprising Al₂O₃.

As used herein, the term “yttria” is understood to be yttrium oxide, comprising Y₂O₃.

As used herein, the term “silica” is understood to be silicon dioxide, comprising SiO₂.

As used herein, the terms “semiconductor wafer,” “wafer,” “substrate,” and “wafer substrate,” are used interchangeable. A wafer or substrate used in the semiconductor device industry typically has a diameter of 200 mm, or 300 mm, or 450 mm.

As used herein, the term “sintered ceramic body” is synonymous with “sinter”, “body” or “sintered body” and refers to a solid ceramic article formed from the powder mixture upon being subjected to a pressure and heat treatment process which creates a monolithic body from the powder mixture.

As used herein, the term “purity” refers to the presence of various contaminants in the bulk starting materials from which a powder mixture may be formed, also in a powder mixture after processing, and in the sintered ceramic body as disclosed herein. Contaminants or “impurities” are considered to be those that may be averse to the intended application. Some elements or compounds, such as for example HfO₂ which may be present in the starting zirconia powder, may not be considered a contaminant due to its very similar chemical behavior to ZrO₂ and as such may not be considered when reporting purity. Y₂O₃ may be added to the zirconia as a phase transformation stabilizer, and as such, may not be considered when reporting purity. Higher purity, closer to 100%, represents a material having essentially no, or very low amounts of, contaminants or impurities, comprising substantially the material compositions present in the starting powders as disclosed.

As used herein, the term “impurity” refers to those compounds/contaminants that are not otherwise added intentionally yet are present in a) the starting materials from which a powder mixture may be formed, b) a powder mixture after processing, and c) a sintered ceramic body comprising impurities other than the starting material itself which comprises Zr, Al and O and optionally dopants. Impurities may arise from the starting materials, powder processing and/or during sintering and may adversely affect the properties of the sintered ceramic bodies disclosed herein. ICPMS methods were used to determine the impurity content of the powders, powder mixtures and formed layers of the sintered body as disclosed herein.

The term “dopant” as used herein is a substance added to a bulk material to produce a desired characteristic in a ceramic material (e.g., to alter electrical properties). Typically, dopants if used are present at low concentrations, i.e., >0.002 wt. % to <0.05 wt.

Impurities differ from dopants in that dopants as defined herein are those compounds intentionally added to the starting powders or to the powder mixture to achieve certain electrical, mechanical, optical or other properties such as grain size modification for example, in the multilayer sintered ceramic body.

As used herein, the term “volumetric porosity” may be synonymous with “porosity” as levels of porosity within the bulk ceramic are representative those on a surface.

As used herein, the term “sintered ceramic body component” refers to a sintered ceramic body after a machining step to create a specific form or shape as necessary for use in a semiconductor processing chamber.

As used herein, the term “powder mixture” means one or more than one powder mixed together prior to a sintering process which after a sintering step are thereby formed into the “sintered ceramic body.”

As used herein, the term “tool set” is one that may comprise a die and two punches and optionally additional spacer elements.

The term “phase” or “crystalline phase” are synonymous and as used herein are understood to mean an ordered structure forming a crystal lattice of a material, including a stoichiometric or compound phase or a solid solution phase. A “solid solution” as used herein is defined as a mixture of different elements that share the same crystal lattice structure. The mixture within the lattice may be substitutional, in which the atoms of one starting crystal replace those of the other, or interstitial, in which the atoms occupy positions normally vacant in the lattice.

As used herein, the terms “stiffness” and “rigidity” are synonymous and consistent with the definition of Young's modulus, as known to those skilled in the art.

The term “calcination” when used as relates to heat treatment processes is understood herein to mean heat treatment steps which may be conducted on a powder in air at a temperature less than a sintering temperature to remove moisture and/or impurities, increase crystallinity and in some instances modify powder mixture surface area.

The term “annealing” when applied to heat treatment of ceramics is understood herein to mean a heat treatment conducted on the disclosed ceramic sintered bodies or sintered ceramic body components to a temperature and allowed to cool slowly to relieve stress and/or normalize stoichiometry. Frequently, an air or oxygen containing environment may be used, but other atmospheres such as vacuum, inert and reducing may also be possible.

As used here, the term “about” as it is used in connection with numbers allows for a variance of plus or minus 10%.

The following detailed description assumes embodiments implemented within equipment such as etch or deposition chambers necessary as part of the making of a semiconductor wafer substrate. However, the disclosure is not so limited. The work piece may be of various shapes, sizes, and materials. In addition to semiconductor wafer processing, other work pieces that may take advantage of the embodiments as disclosed herein include various articles such as fine feature size inorganic circuit boards, magnetic recording media, magnetic recording sensors, mirrors, optical elements, micro-mechanical devices and the like.

### Compositions

The following detailed description assumes the invention is implemented within equipment such as etch or deposition chambers necessary as part of the making of a semiconductor wafer substrate. However, the invention is not so limited. The work piece may be of various shapes, sizes, and materials. In addition to semiconductor wafer processing, other work pieces that may take advantage of this invention include various articles such as fine feature size inorganic circuit boards, magnetic recording media, magnetic recording sensors, mirrors, optical elements, micro-mechanical devices and the like.

During processing of semiconductor devices, corrosion resistant parts or chamber components are used within etch and deposition chambers and exposed to harsh corrosive environments which cause the release of particles into the etch chamber, resulting in yield loss due to wafer-level contamination. The sintered ceramic body and related components as disclosed herein provide improved plasma etch resistance and enhanced ability to be cleaned within semiconductor processing chambers by way of specific material properties and features to be described following.

Semiconductor processing reactors as relates to etch or deposition processes require chamber components fabricated from materials having high resistance to chemical corrosion by reactive plasmas necessary for semiconductor processing. These plasmas or process gases may be comprised of various halogen, oxygen and nitrogen-based chemistries such as O₂, F, Cl₂, HBr, BCl₃, CCl₄, N₂, NF₃, NO, N₂O, C₂H₄, CF₄, SF₆, C₄F₈, CHF₃, CH₂F₂. Use of the corrosion resistant materials as disclosed herein provides for reduced chemical corrosion during use. Additionally, providing a chamber component material such as a sintered ceramic body having a very high purity provides a uniformly corrosion resistant body low in impurities which may serve as a site for initiation of corrosion. High resistance to erosion or spalling is also required of materials for use as chamber components. Erosion or spalling may result from ion bombardment of component surfaces through use of inert plasma gases such as Ar. Those materials having a high value of hardness may be preferred for use as components due to their enhanced hardness values providing greater resistance to ion bombardment and thereby, erosion. Further, components fabricated from highly dense materials having minimal porosity distributed at a fine scale may provide greater resistance to corrosion and erosion during etch and deposition processes. As a result, preferred chamber components may be those fabricated from materials having high erosion and corrosion resistance during plasma etching, deposition and chamber cleaning processes. This resistance to corrosion and erosion prevents the release of particles from the component surfaces into the etch or deposition chambers during semiconductor processing. Such particle release or shedding into the process chamber contributes to wafer contamination, semiconductor process drift and semiconductor device level yield loss.

Additionally, chamber components must possess sufficient flexural strength and rigidity for handleability as required for component installation, removal, cleaning and during use within process chambers. High mechanical strength allows for machining intricate features of fine geometries into the sintered ceramic body without breakage, cracking or chipping. Flexural strength or rigidity becomes particularly important at large component sizes used in state-of-the-art process tools. In some component applications such as a dielectric or RF window as used in a semiconductor processing chamber of diameter on the order of 200 to 620 mm or 625 mm, significant stress is placed upon the window during use under vacuum conditions, necessitating selection of corrosion resistant materials, or the sintered ceramic body as disclosed herein used as a substrate, of high strength and rigidity.

Preferable for semiconductor chamber components are those materials which have as low dielectric loss as possible in order to improve plasma generation efficiency, in particular at the high frequencies of between 1 MHz to 20 GHz used in plasma processing chambers. Heat generated by absorption of microwave energy in those component materials having higher dielectric loss causes non-uniform heating and increased thermal stresses upon components, and the combination of thermal and mechanical stresses during use may result in limitations to product designs and complexity.

To meet the requirements, disclosed herein is a sintered ceramic body having at least one surface, the sintered ceramic body comprising: a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size of from 0.1 to 5 μm as measured by SEM, wherein sintered ceramic body exhibits a coefficient of thermal expansion of from 6.899 to 9.630×10⁻⁶/° C. across a temperature range of from 25-200° C. to 25-1400° C. as measured in accordance with ASTM E228-17, wherein the sintered ceramic body has a relative density of from 99% to 100% and has a density variation of from 0.2 to less than 5% across a greatest dimension, wherein the greatest dimension is from 200 to 625 mm, and wherein Si is either not present in the sintered ceramic body or it is present in the sintered ceramic body in an amount of 100 ppm or less. Compositions comprising mixtures of alumina and zirconia are sometimes referred to herein as “zirconia toughened alumina” or “ZTA”.

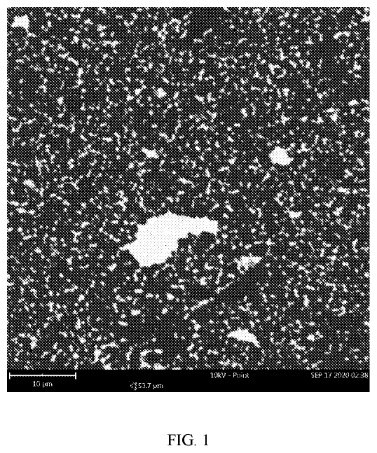

In embodiments exemplified by FIG. 1, the sintered ceramic body disclosed herein has a matrix or composite structure of two or more discrete or continuous phases, wherein the first crystalline phase comprises Al₂O₃ and the second crystalline phase comprises ZrO₂, wherein the first crystalline phase is a continuous matrix and the second crystalline phase is dispersed in the continuous matrix. In FIG. 1, the distinct zirconia crystalline phase (white) is distributed throughout the alumina crystalline matrix (black) uniformly, meaning that, to the extent that there are larger regions of discrete zirconia phase, the discrete zirconia phase comprises a largest dimension of 15 μm and less, preferably 10 μm and less, preferably 8 μm and less, preferably 5 μm and less, preferably 3 μm and less, preferably 1 μm and less, across a polished surface having an area of 54 μm×54 μm. In embodiments, the zirconia crystalline phase is present in the sintered ceramic body in an amount of from 8 vol. % to 20 vol. %, in some embodiments from 12 vol. % to 25 vol. %, or from 5 vol. % to 25% vol. %, or from 10 vol. % to 25 vol. %, or from 15 vol. % to 25 vol. %, or from 15 vol. % to 17 vol. %, or from 20 vol. % to 25 vol. %, or from 5 vol. % to 20 vol. %, from 14 vol. % to 18 vol. %, or from 5 vol. % to 15 vol. %, or from 5 vol. % to 10 vol. %, or from 15 vol. % to 20 vol. % of the sintered ceramic body.

The sintered ceramic body prepared in accordance with the method as disclosed, and sintered ceramic body components made from said sintered body preferably have high densities. Density measurements were performed using the Archimedes method as known in the art. The ceramic sintered bodies as disclosed herein may have density of for example from 98 to 100%, from 99 to 100%, from 99.5 to 99.99%, or from 99.5 to 100%, which may provide enhanced resistance to the effects of erosion and corrosion resulting from plasma etch and deposition processing.

The following Table provides examples of densities of large parts made of alumina and zirconia according to the present disclosure.

| Solid part | Zro₂ | Zro₂ | Measured Density | Relative Density |
|---|---|---|---|---|
| number | (Vol %) | (Mass %) | (g/cc) | (% RD) |
| 215W21B | 8 | 11.8 | 4.125 | 99.4 |
| 214W21B | 10 | 14.5 | 4.187 | 99.9 |
| 213W21B | 12 | 17.3 | 4.236 | 100 |
| 225W21B | 14 | 19.9 | 4.278 | 100 |
| 104W21C | 16 | 22.6 | 4.309 | 99.8 |
| 175W21C-1 | 18 | 25.1 | 4.357 | 99.9 |
| 176W21C | 20 | 27.7 | 4.403 | 100 |

The relative density (RD) for a given material is defined as the ratio of the measured density using the Archimedes method of the sample to the reported theoretical density for the same material, as shown in the following equation. Volumetric porosity (Vp) is calculated from density measurements as follows:

$$R D = \frac{ρ sample}{ρ theoretical} = 1 - V p$$

where p sample is the measured (Archimedes) density according to ASTM B962-17, p theoretical is the reported theoretical density, and RD is the relative fractional density. Using this calculation, porosity levels by percent of from about 0.1 to 2% were calculated from measured density values for the ceramic sintered bodies as disclosed herein. Thus, in embodiments, the sintered ceramic body may comprise volumetric porosity in amounts of from 0.1 to 2%, preferably from 0.1 to 1.5%, preferably from 0.1 to 1%, preferably from 0.1 to 0.5% in the sintered ceramic body.

The high densities, and thereby high mechanical strength, of the ceramic sintered bodies disclosed herein also provide increased handleability, in particular at large dimensions. Successful fabrication of sintered ZTA bodies is achieved by controlling variation in density across at least one longest dimension (e.g., from about 200 to 625 mm). An average density of 98.5% and greater and 99.5% and greater as shown above is obtainable, with a variation in density of 5% or less, preferably 4% or less, preferably 3% or less, preferably 2% or less, preferably 1% or less across the greatest dimension, whereby the greatest dimension may be for example about 625 mm and less, 622 mm and less, 610 mm and less, preferably 575 mm and less, preferably 525 mm and less, preferably from 100 to 625 mm, preferably from 100 to 622 mm, preferably from 100 to 575 mm, preferably from 200 to 625 mm, preferably from 200 to 510 mm, preferably from 400 to 625 mm, and preferably from 500 to 625 mm. Reducing the variation in density may improve handleability and reduce overall stress in the ceramic sintered body.

The ceramic sintered bodies as disclosed herein may have very small pores both on the surface and throughout. Preferably, the ceramic sintered bodies made according to the process disclosed herein are, thus, integral bodies having pores distributed uniformly throughout. In other words, pores or voids or porosity measured on a surface may be representative of pores or voids or porosity within the bulk corrosion resistant layer. Thus, volumetric porosity present within the bulk ceramic body as disclosed herein is also representative of porosity measured across a surface.

Correspondingly, the sintered ceramic bodies disclosed herein have pores or voids, however, the level of porosity is very low and may provide improved performance in plasma etch and deposition applications and facilitate extensive cleaning to levels required of semiconductor processing systems. This results in extended component lifetimes, greater process stability and reduced chamber downtime for cleaning and maintenance. Disclosed herein is a nearly dense or fully dense solid body sintered ceramic body having minimal porosity. This minimal porosity may enable reductions in particle generation by preventing entrapment of contaminants in the surface of the sintered ceramic body during etch and deposition processes. In some embodiments where the sintered ceramic body may serve as a substrate for subsequent deposition of corrosion resistant layers through aerosol, plasma spray and other techniques, this low level of porosity may enable formation of very thin such as for example from about 1 to 20 μm, corrosion resistant films which are uniform and may be free of voids or porosity.

Correspondingly, it may be advantageous for the sintered ceramic body to have a small percentage of a surface area comprised of porosity, in combination with porosity of small diameters and controlled pore size distribution. The corrosion resistant sintered ceramic body as disclosed herein may have a porosity below 2%, preferably below 1%, preferably below 0.5% in the sintered ceramic body, providing improved etch resistance by way of controlled area of porosity of the surface, frequency of pores, and fine dimensions of porosity. Preferably, the pores have a maximum pore size of from 0.1 to 5 μm, preferably from 0.1 to 4 μm, more preferably from 0.1 to 3 μm, more preferably from 0.1 to 2 μm, and most preferably from 0.1 to 1 μm as determined by SEM.

In embodiments, the porosity across a surface of a sintered ceramic body as disclosed herein is in an amount of from 0.0005 to 2%, preferably from 0.0005 to 1%, preferably from 0.0005 to 0.5%, preferably from 0.0005 to 0.05%, preferably from 0.0005 to 0.005%, preferably from 0.0005 to 0.003%, preferably from 0.0005 to 0.001%, preferably from 0.005 to 2%, preferably from 0.05 to 2%, preferably from 0.5 to 2%, preferably from 0.005 to 2%, preferably from 0.005 to 1%, preferably from 0.05 to 2%, preferably from 0.05 to 1%, and preferably from 0.5 to 2%.

In addition to high density, high hardness values further provide enhanced resistance to erosion during use as a plasma chamber component. As such, Vickers hardness measurements were performed in accordance with ASTM Standard C1327 “Standard Test Method for Vickers Indentation Hardness of Advanced Ceramics.” Hardness values of from 17 to 23 GPa, preferably from 18 to 22 GPa, preferably about 20 GPa, may be obtained for the sintered ceramic body as disclosed herein. These high hardness values may contribute to enhanced resistance to ion bombardment during semiconductor etch processes and reduced erosion during use, providing extended lifetimes when the sintered ceramic body is machined into sintered ceramic body components having fine scale features.

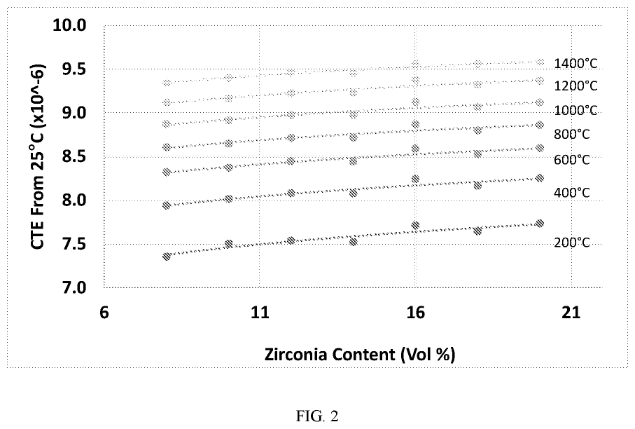

The sintered ceramic bodies disclosed herein exhibit a coefficient of thermal expansion of from 6.899 to 9.630×10⁻⁶/° C., in some embodiments from 7.113 to 7.326×10⁻⁶/° C., in other embodiments from 6.685 to 6.899×10⁻⁶/° C., in other embodiments from 6.685 to 7.113×10⁻⁶/° C., in other embodiments from 6.685 to 7.54×10⁻⁶/° C., in yet other embodiments from 7.540 to 9.515×10⁻⁶/° C., in yet other embodiments from 7.326 to 9.515×10⁻⁶/° C., in yet other embodiments from 7.113 to 9.515×10⁻⁶/° C., in yet other embodiments from 6.899 to 9.515×10⁻⁶/° C., and in still other embodiments from 6.685 to 9.515×10⁻⁶/° C., across a temperature range from 25-200° C. to 25-1400° C. Referring now to FIG. 2, the coefficient of thermal expansions are plotted comparing compositions having varying amounts of zirconia from 8 to 20% by volume, across a temperature range from 25-200° C. to 25-1400° C. Compositions of the sintered ceramic body may be tailored to produce specific CTE characteristics based upon the volume of zirconia in alumina. The sintered ceramic body may be formed across a compositional range of zirconia such that the CTE may vary from 25-200° C. to 25-1400° C. from about 6.899×10⁻⁶/° C. for 10% by volume of zirconia, to about 9.630×10⁻⁶/° C. for about 25 volume % zirconia as shown in the following table listing the data illustrated by FIG. 2.

| % | 25- | 25- | 25 | 25- | 25- | 25- | 25- |
|---|---|---|---|---|---|---|---|
| ZrO₂ | 1400° C. | 1200° C. | 1000° C. | 800° C. | 600° C. | 400° C. | 200° C. |
| 8 | 9.3446 | 9.1177 | 8.8734 | 8.6054 | 8.3214 | 7.9394 | 7.3542 |
| 10 | 9.4000 | 9.1652 | 8.9127 | 8.6493 | 8.3718 | 8.0140 | 7.5019 |
| 12 | 9.4638 | 9.2263 | 8.9743 | 8.7142 | 8.4471 | 8.0790 | 7.5354 |
| 14 | 9.4605 | 9.2318 | 8.9773 | 8.7153 | 8.4438 | 8.0782 | 7.5199 |
| 16 | 9.5584 | 9.3765 | 9.1229 | 8.8666 | 8.5919 | 8.2439 | 7.7110 |
| 18 | 9.5575 | 9.3247 | 9.0683 | 8.7982 | 8.5276 | 8.1678 | 7.6443 |
| 20 | 9.5806 | 9.3662 | 9.1176 | 8.8624 | 8.5966 | 8.2536 | 7.7356 |

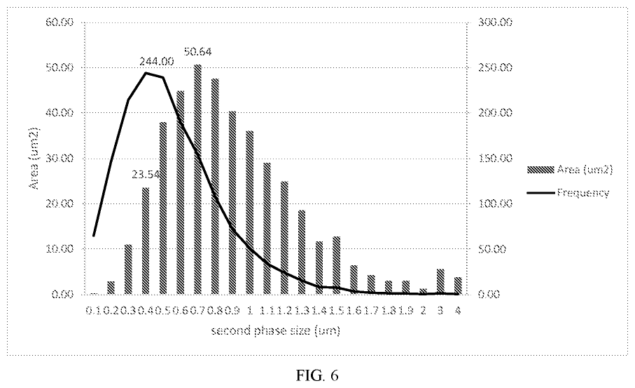

FIG. 6 illustrates the total discrete region area by second phase size, and frequency of the total discrete region area by second phase size, for the second crystalline phase comprising discrete regions of zirconia according to embodiments as disclosed herein. The greatest frequency of discrete region area occurs at a count of 244 regions thus this is taken as an average area of discrete regions comprising the second phase as disclosed herein. Thus, in embodiments, disclosed herein is a sintered ceramic body comprising a second crystalline phase having discrete regions wherein any one region has an average area of from 10 to 30 μm², preferably from 10 to 25 μm², preferably from 10 to 20 μm², preferably from 15 to 25 μm², and preferably about 23 μm². The average area of the discrete regions comprising the second crystalline phase enable the formation of sintered ceramic bodies having controlled CTE characteristics, high fracture toughness, and high strengths. If the maximum area of the discrete regions is greater than, for example, 100 μm², the CTE difference between the first and second crystalline phases may cause cracking in the microstructure close to large discrete regions of the second crystalline phase. The finely dispersed discrete regions, represented by the average and maximum areas of the second crystalline phase, provide enhanced fracture toughness and strength to the sintered ceramic body. Thus, in embodiments it is preferable to have a maximum area of the discrete regions comprising a second phase of zirconia of about 60 μm² and less, preferably about 55 μm² and less, preferably about 50 μm² and less.

Mechanical strength properties are known to improve with decreasing grain size. In order to assess grain size, linear intercept grain size measurements were performed in accordance with the Heyn Linear Intercept Procedure described in ASTM standard E112-2010 “Standard Test Method for Determining Average Grain Size.” To meet the requirements of high flexural strength and rigidity for use in reactor chambers as large components of between 200 to 600 mm, for example, the sintered ceramic body disclosed herein has a fine grain size. In embodiments, the first crystalline phase has a grain size of from 1 to 5 μm, preferably from 2 to 5 μm, preferably from 3 to 5 μm, preferably from 1 to 4 μm, and preferably from 2 to 3 μm and the second crystalline phase has a grain size of from 0.5 to 4 μm, preferably from 1 to 4 μm, preferably from 2 to 4 μm, preferably from 0.5 to 3 μm, and preferably from 0.5 to 2 μm as measured according to ASTM E112-2010. These grain sizes may result in a sintered ceramic body having a 4-point bend flexural strength of 300 MPa and less, preferably 350 MPa and less, preferably at least 400 MPa. Grain sizes too large in diameter, on the order of 20 um and greater, may result in ceramic sintered bodies having low flexural strength values which may make them unsuitable for use as etch chamber components in particular of large dimension, thus it is preferable for the sintered ceramic body to have an average grain size of preferably less than 3 um.

Providing materials low in dielectric loss also becomes important at increasing frequencies. The ceramic sintered bodies disclosed herein may be tailored within a certain application-specific range of between about 5×10⁻² to 5×10⁻⁵ or less across a frequency range of between 1 MHz to 20 GHz. Material properties such as purity of the starting powders, and in particular, the silica content in the sintered ceramic body may affect dielectric loss. In embodiments, low silica content, if any, in starting materials may provide a sintered ceramic body to meet the dielectric loss requirements as stated. In preferred embodiments, Si is either not present at a detectable level in the sintered ceramic body or it is present in an amount of 100 ppm or less such as, for example, from 14 ppm to 100 ppm, preferably from 14 to 75 ppm, preferably from 14 to 50 ppm, preferably from 14 to 25 ppm, preferably from 14 to 20 ppm. In one embodiment, Si is present in the sintered ceramic body, if at all, at a concentration of no more than 50 ppm. In another embodiment, Si is present in the sintered ceramic body, if at all, at a concentration of no more than 14 ppm. In another embodiment, Si is present in the sintered ceramic body, if at all, at a concentration of no more than 10 ppm. In yet another embodiment, Si is present in the sintered ceramic body, if at all, at a concentration of no more than 7 ppm.

In addition, dielectric loss may be affected by grain size and grain size distribution. Fine grain size also may provide reduced dielectric loss, and thereby reduced heating upon use at higher frequencies. These material properties may be adjusted through material synthesis to meet specific loss values dependent upon component application within processing chambers.

The sintered ceramic bodies disclosed herein may be among the most etch resistant materials known, and the use of high purity starting materials to fabricate a sintered ceramic body of very high purity and density as a starting material provides the inherent etch resistant properties in a ceramic sintered component. However, highly pure oxides pose challenges to sinter to the high densities required for application to semiconductor etch chambers. The material properties of oxides of a high sintering temperature and plasma etch resistance present challenges in sintering to high density while maintaining the necessary high purity as sintering aids are often required to achieve high (greater than 98%, 99% or 99.5%) density. This high purity prevents roughening of the surface of the sintered ceramic body by halogen based gaseous species which may otherwise chemically attack, surface-roughen, and etch those components made from powders lower in purity. For the aforementioned reasons, a total purity of greater than 99.99%, preferably greater than 99.999% preferably greater than 99.9999% in the alumina and zirconia starting material may be preferable. Correspondingly, in embodiments, the alumina and zirconia powders from which the sintered ceramic bodies are made are free of sintering aids with the exception of magnesia and silica which may be present in the ranges as disclosed.

Total purity of the sintered ceramic body as disclosed herein may have a purity of 99.985% and higher, 99.99% and higher, preferably 99.995% and higher, more preferably 99.999% and higher. Said another way, the sintered ceramic body as disclosed herein may have a total impurity content of less than 100 ppm, preferably less than 75 ppm, less than 50 ppm, preferably less than 25 ppm, preferably less than 15 ppm, preferably less than 10 ppm, preferably less than 8 ppm, preferably less than 5 ppm, preferably from 5 to 30 ppm, and preferably from 5 to 20 ppm relative to a total mass of the sintered ceramic body as measured using ICPMS methods. The total impurity contents as disclosed herein do not include Si in the form of silica.

In particular, the sintered ceramic body disclosed herein has impurities of 50 ppm or less of trace metals Na, Fe, and Mg as determined by ICPMS. In another embodiment, the sintered ceramic body as disclosed herein has impurities of 5 ppm or less of trace metals Na, Fe, and Mg as determined by ICPMS. In yet another embodiment, the the sintered ceramic body as disclosed herein has a purity of 50 ppm or less of trace elements Li, Na, Mg, K, Ca, B, P, Fe, Cu, Cr, Zn, In, Sn, and Sb (total) as determined by ICPMS.

Detection limits using the ICP-MS methods as disclosed herein to identify presence of lighter elements are higher than reporting limits of heavier elements. In other words, heavier elements, such as from Sc and higher, are detected with greater accuracy, for example to as low as 0.06 ppm, than those lighter elements, from for example Li to Al (detected at for example accuracy of as low as 0.7 ppm). Thus, impurity contents for those powders comprising lighter elements, such as from Li to Al, may be determined to about 0.7 ppm and greater, and impurity contents of heavier elements, from Sc (scandium) to U (uranium) may be determined to about 0.06 ppm and greater. Using the ICPMS methods as disclosed herein, K (potassium) and Ca (calcium) may be identified in amounts of 1.4 ppm and greater. Iron may be detected with accuracy in amounts of as low as 0.14 ppm. Trace amounts of yttria and hafnia may be present in the sintered ceramic body as these oxides are often used as stabilizers for zirconia and, thus, are not impurities. The purity of the ceramic sintered component may be retained from that of the sintered ceramic body.

The surface of the sintered ceramic body as disclosed herein, both before and after an etching process, may be correlated to particulate generation in processing chambers. Thus, it is beneficial generally to have a reduced surface roughness. The parameters of Sa (arithmetical mean height), Sz (maximum height) and Sdr (developed interfacial area) were measured on the sintered ceramic body. Generally, surface roughness after a plasma etch process may affect chamber particle generation in that low surface roughness, provided by corrosion resistant materials, reduces the release of contaminate particles into the chamber and correspondingly higher surface roughness after the etch may contribute to particle generation and release onto the wafer. Additionally, smoother surfaces as indicated by the lower surface roughness values of Sa, Sz and Sdr enable the chamber components as disclosed herein to be more easily cleaned to semiconductor grade levels.

Surface roughness measurements can be performed using a Keyence 3D laser scanning confocal digital microscope model VK-X250×under ambient conditions in a class 1 cleanroom. The microscope rests on a TMC tabletop CSP passive benchtop isolator with 2.8 Hz Natural Frequency. This non-contact system uses laser beam light and optical sensors to analyse the surface through reflected light intensity. The microscope acquires 1,024 data points in the x direction and 786 data points in the y direction for a total of 786,432 data points. Upon completion of a given scan, the objective moves by the pitch set in the z direction and the intensity is compared between scans to determine the focus. The ISO 25178 Surface Texture (Areal Roughness Measurement) is a collection of international standards relating to the analysis of surface roughness with which this microscope is compliant.

The surface of samples is typically laser scanned using the confocal microscope at 10× magnification to capture a detailed image of the sample. Line roughness is obtained on a profile of 7 partitioned blocks. The lambda chi(λ), which represents the measurement sampling lengths, can be adjusted so that the line reading is limited to measurements from the 5 middle blocks of the 7 according to ISO specification 4288: Geometrical Product Specifications (GPS)—Surface texture: Profile method—Rules and procedures for the assessment of surface texture.

Areas can be selected within etched and unetched regions of a sample for measurement and used to calculate Sa, Sz and Sdr.

Sa represents an average roughness value calculated across a user-defined area of a surface of the sintered ceramic body. Sz represents the maximum peak-to-valley distance across a user-defined area of a surface of the sintered ceramic body. Sdr is a calculated numerical value defined as the “developed interfacial area ratio” and is a proportional expression for an increase in actual surface area beyond that of a completely flat surface. A flat surface is assigned an Sdr of zero, and the value increases with the slope of the surface. Larger numerical values correspond with greater increases in surface area. This allows for numerical comparison of the degree of surface area increase between samples. It represents additional surface area arising from texture or surface features as compared to a planar area.

The surface roughness features of Sa, Sz and Sdr are well-known parameters in the underlying technical field and, for example, described in ISO standard 25178-2-2012, section 4.3.2.

The present disclosure relates to a sintered ceramic body having a corrosion resistant surface before an etch or deposition process providing an arithmetical mean height, Sa, of less than 30 nm, more preferably less than 20 nm, more preferably less than 15 nm, more preferably less than 12 nm, more preferably less than 10 nm, preferably from 3 to 25 nm, preferably from 3 to 20 nm, preferably from 3 to 10 nm, preferably from 3 to 8 nm according to ISO standard 25178-2-2012, section 4.1.7. surface roughness and not exceeding a specific value, and a controlled distribution of porosity.

The table following lists Sa, Sz and Sdr measurement results for a sintered ceramic body as disclosed herein.

| | Sa | Sz | |
|---|---|---|---|
| | μm | μm | Sdr |
| | 0.004 | 0.414 | 0.0002964 |
| | 0.003 | 0.364 | 0.0002861 |
| | 0.003 | 0.342 | 0.0002431 |
| | 0.004 | 0.616 | 0.0004091 |
| Average | 0.003 | 0.434 | 0.0003 |
| SD | 0.0001 | 0.125 | 0.0001 |

The present disclosure relates to a sintered ceramic body having a corrosion resistant surface before an etch or deposition process providing a maximum height, Sz, of less than 5.0 μm, more preferably loss than 4.0 μm, most preferably less than 3.5 μm, more preferably less than 2.5 μm, more preferably less than 2 μm, more preferably less than 1.5 μm, more preferably less than 1 μm, according to ISO standard 25178-2-2012, section 4.1.7. surface roughness and not exceeding a specific value, and a controlled distribution of porosity.

The present disclosure relates to a sintered ceramic body having a corrosion resistant surface before an etch or deposition process providing a developed interfacial area, Sdr, of less than 100×10⁻⁵, more preferably loss than 80×10⁻⁵, more preferably less than 600×10⁻⁵, more preferably less than 50×10⁻⁵, according to ISO standard 25178-2-2012, section 4.1.7. surface roughness and not exceeding a specific value, and a controlled distribution of porosity.

In some embodiments where the sintered ceramic body may serve as a substrate for subsequent deposition of corrosion resistant layers through aerosol, plasma spray and other techniques, these low values for Sa, Sz and Sdr as disclosed herein may enable formation of very thin, such as for example from about 1 to 20 um, corrosion resistant films which may be uniform and may be free of voids or porosity.

### Method of Preparing

Preparation of the sintered ceramic body may be achieved by use of pressure assisted sintering combined with direct current sintering and related techniques, which employ a direct current to heat up an electrically conductive die configuration or tool set, and thereby a material to be sintered. This manner of heating allows the application of very high heating and cooling rates, enhancing densification mechanisms over grain growth promoting diffusion mechanisms, which may facilitate preparation of ceramic sintered bodies of very fine grain size, and transferring the intrinsic properties of the original powders into their near or fully dense products.

Disclosed is a method for preparing a sintered ceramic body, the method comprising the steps of: a) combining aluminum oxide powder and zirconium oxide powder to make a powder mixture, wherein the aluminum oxide powder and the zirconium oxide powder each has a total impurity content of less than 150 ppm; b) calcining the powder mixture by applying heat to raise the temperature of the powder mixture to a calcination temperature and maintaining the calcination temperature to perform calcination to form a calcined powder mixture; c) disposing the calcined powder mixture inside a volume defined by a tool set of a sintering apparatus and creating vacuum conditions inside the volume; d) applying pressure to the calcined powder mixture while heating to a sintering temperature and performing sintering to form the sintered ceramic body; and e) lowering the temperature of the sintered ceramic body. The following additional steps are optional: f) optionally annealing the sintered ceramic body by applying heat to raise the temperature of the sintered ceramic body to reach an annealing temperature, performing annealing; g) lowering the temperature of the annealed sintered ceramic body to an ambient temperature by removing the heat source applied to the sintered ceramic body; and h) machining the sintered ceramic body to create a sintered ceramic body component such as a dielectric window or RF window, a focus ring, a nozzle or a gas injector, a shower head, a gas distribution plate, an etch chamber liner, a plasma source adapter, a gas inlet adapter, a diffuser, an electronic wafer chuck, a chuck, a puck, a mixing manifold, an ion suppressor element, a faceplate, an isolator, a spacer, and/or a protective ring in etch chambers. The result is a sintered ceramic body having at least one surface, the sintered ceramic body comprising: a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size of from 0.1 to 5 μm as measured by SEM, wherein sintered ceramic body exhibits a coefficient of thermal expansion of from 6.899 to 9.630×10⁻⁶/° C. across a temperature range of from 25-200° C. to 25-1400° C. as measured in accordance with ASTM E228-17, wherein the sintered ceramic body has a relative density of from 99% to 100% and has a density variation of from 0.2 to less than 5% across a greatest dimension, wherein the greatest dimension is from 200 to 625 mm, and wherein Si is either not present in the sintered ceramic body or it is present in the sintered ceramic body in an amount of 100 ppm or less.

The above-mentioned characteristics of the corrosion resistant component formed from the sintered ceramic body are achieved in particular by adapting the purity of the powders of aluminium oxide and zirconium oxide, the pressure to the powders of aluminum oxide and zirconium oxide, the temperature of the powders of aluminum oxide and zirconium oxide, the duration of sintering the powders, the temperature of the sintered ceramic body/sintered ceramic body component during the optional annealing step, and the duration of the annealing step.

The method disclosed herein provides for the preparation of sintered ceramic body components comprised of a zirconia toughened aluminum oxide. The aforementioned compositions may in some embodiments also be made with an optional rare earth oxide dopant selected from the group consisting of Sc, La, Ce, Pr, Nd, Pm, Sm, Eu, Gd, Tb, Dy, Ho, Tm, Yb, and Lu and oxides thereof in amounts up to and including 1 wt. %, which may be added into the powder mixture at step a). In some embodiments, the aluminum oxide and zirconium oxide powders are mixed without a dopant.

The characteristics of the sintered ceramic body and sintered ceramic body components according to an embodiment are achieved by adapting step a) powder mixing/combining and b) heat treating the powder mixture before sintering, the purity, the particle size and surface area of the starting powders of aluminum oxide and zirconium oxide powder used in step a), the surface area and uniformity of the starting materials used in step a), the pressure to the powder mixture in step d), the sintering temperature of the powder mixture in step d), the duration of sintering of the powder mixture in step d), the temperature of the sintered ceramic body or component during the optional annealing step in step f), and the duration of the optional annealing step f). The resulting sintered ceramic body is particularly suitable for use as a sintered ceramic body or corrosion-resistant member in a plasma processing apparatus such as a semiconductor manufacturing apparatus. Such parts or members may include windows, nozzles, gas injectors, shower heads, (etch) chamber liners, mixing manifolds, wafer supports, electronic wafer chucks, and various rings such as focus rings and protective rings, among other components.

The ceramic sintered bodies of the present disclosure not only exhibit high strength but also low loss of RF transmission when used in semiconductor processing tools. This feature makes them especially suited for use as dielectric or RF windows.

Step a) of the method disclosed herein comprises combining powders comprising aluminum oxide and zirconium oxide to make a powder mixture. The starting materials of aluminum oxide and zirconium oxide for forming a sinter and/or component are preferably high purity commercially available powders.

The particle size of the aluminum oxide powder used as a starting material according to one embodiment is usually from 0.05 to 5 μm, preferably from 0.1 to 3 μm, and more preferably from 0.2 to 2 μm. The aluminum oxide powder usually has a specific surface area of from 1 to 18 m²/g, more preferably between 4 to 16 m²/g, and most preferably from 6 to 12 m²/g. The purity of the aluminum oxide starting material is typically higher than 99.0%, preferably higher than 99.96%, more preferably higher than 99.995%.

The zirconium oxide powder may have a particle size distribution having a d10 of between 0.08 and 0.20 um, a d50 of between 0.3 and 0.7 um and a d90 of between 0.9 and 5 μm. The average particle size of the zirconium oxide powder used as a starting material for the mixture according to one embodiment of the present invention may be from 1 to 3 um.

The zirconia powder typically has a specific surface area of from 1 to 16 m²/g, preferably between 2 to 10 m²/g, and more preferably between 5 to 8 m²/g. The purity of the zirconia powder starting material is typically higher than 99.0%, preferably higher than 99.5%, preferably higher than 99.97%, and preferably higher than 99.99%.

The alumina and zirconia powders are mixed in proportions such that the zirconia is present in the mixture from from 5 to 25%, preferably from 10 to 25%, preferably from 15 to 25%, preferably from 20 to 25%, preferably from 5 to 20%, preferably from 5 to 15%, preferably from 5 to 10%, preferably from 15 to 20% each by volume of the sintered ceramic body.

Combining the alumina and zirconia powders to make a powder mixture may be performed using the conventional powder preparation techniques of ball milling, wet mixing and dry mixing. Ball milling may be accomplished using alumina media as one example and conducted according to methods as known to those skilled in the art. In other instances, a harder media such as zirconium oxide may be used. Use of ball milling is a high energy process which breaks down particulates and agglomerates and may provide for a homogeneous powder mixture prior to calcination. Ball milling may be performed either in wet or dry conditions. Wet mixing may be performed using various solvents, for example ethanol or water, with minimal or no media during mixing, and may be conducted according to methods as known to those skilled in the art. Wet mixing provides for improved dispersion of the powders through increased mobility, resulting in fine scale, uniform mixing before heat treatment or calcination. Dry mixing may be conducted with or without media according to purity requirements in the final sintered ceramic body, and performed in accordance with methods known to those skilled in the art. The additional powder preparation procedures of attrition milling, high shear mixing, planetary milling, and other known procedures may also be applied. The powder slurries are dried according to known methods. The aforementioned powder preparation techniques may be used alone or in any combination thereof, or upon more than one powder mixture which are thereafter combined into a final, sintered ceramic body.

Step b) of the method disclosed herein is calcining the powder mixture by applying heat to raise the temperature of the powder mixture to a calcination temperature and maintaining the calcination temperature to perform calcination. This step may be conducted such that moisture may be removed and surface condition of the powder mixture is uniform prior to sintering. Calcination in accordance with the heat treatment step may be performed at temperatures of from about 600° C. to about 1400° C. for a duration of 4 to 12 hours in an oxygen containing environment. The surface area of the powder mixture may be from 1 to 18 m²/g, from 3 to 15 m²/g, or from 3 to 10 m²/g. After calcination, the powders may be sieved and/or tumbled according to known methods.

After calcination, the calcined powder mixture typically has a specific surface area of from 1 to 12 m²/g, preferably from 2 to 10 m²/g, preferably from 3 to 9 m²/g, preferably from 4 to 8 m²/g.

Step c) of the method disclosed herein is disposing the calcined powder mixture inside a volume defined by a tool set of a spark plasma sintering apparatus and creating vacuum conditions environment inside the volume. A sintering apparatus used in the process according to an embodiment comprises at least a graphite die which is usually a cylindrical graphite die. In the graphite die the powder mixture is disposed between two graphite punches or in some instances between spacer elements. At least one powder mixture may be loaded into the die of the sintering apparatus. Vacuum conditions as known to those skilled in the art are established within the volume created by the punches and die.

In preferred embodiments, the spark plasma sintering (SPS) tool comprises a die comprising a sidewall comprising an inner wall and an outer wall, wherein the inner wall has a diameter that defines an inner volume capable of receiving at least one ceramic powder; and an upper punch and a lower punch operably coupled with the die, wherein each of the upper punch and the lower punch have an outer wall defining a diameter that is less than the diameter of the inner wall of the die thereby defining a gap between each of the upper punch and the lower punch and the inner wall of the die when at least one of the upper punch and the lower punch are moved within the inner volume of the die, wherein the gap is from 10 μm to 100 μm wide. Preferably, the die and punches are made of graphite. Such SPS tool is disclosed in U.S. provisional patent application Ser. No. 63/087,204, filed Oct. 3, 2020, which is herein incorporated by reference.

The method as disclosed utilizes commercially available powders or those prepared from chemical synthesis techniques, without the need for sintering aids, cold pressing, forming or machining a green body prior to sintering.

Step d) of the method is applying pressure to the calcined powder mixture while heating to a sintering temperature and performing sintering to form the sintered ceramic body and step e is lowering the temperature of the sintered ceramic body by, for example, removing the heat source to the sintering apparatus to cool the sinter. After the powder mixture is disposed in the volume defined by the die and punches, pressure is applied to the powder mixture disposed between the graphite punches. Thereby, the pressure is increased to a pressure of from 5 MPa to 100 MPa, preferably between 10 MPa to 50 MPa, preferably between 15 MPa to 45 MPa, preferably between 20 and 40 MPa. The pressure is applied axially on the material provided in the die.

In preferred embodiments, the powder mixture is heated directly by the punches and die of the sintering apparatus. The die and punches may be comprised of an electrically conductive material such as graphite, which facilitates resistive/joule heating. The sintering apparatus and procedures are disclosed in US 2010/0156008 A1, which is incorporated herein by reference.

The temperature of the sintering apparatus according to the present disclosure is measured usually within the graphite die of the apparatus. Thereby, it is preferred that the temperature is measured as close as possible to the powder being processed so that the indicated temperatures are indeed realized within the powder mixture to be sintered.

The application of heat to the powder mixture provided in the die facilitates sintering temperatures from about 1000 to 1700° C., preferably from about 1050 to 1600° C., more preferably from about 1300 to 1500° C. Final sintering may typically be achieved with a time of between 0.5 to 1440 minutes, preferably between 0.5 to 720 minutes, preferably between 0.5 to 360 minutes, preferably between 0.5 to 240 minutes, preferably between 0.5 to 120 minutes, preferably between 0.5 to 60 minutes, preferably between 0.5 to 30 minutes, preferably between 0.5 to 20 minutes, preferably between 0.5 to 10 minutes, preferably between 0.5 to 5 minutes. In process step e), the sintered ceramic body is passively cooled by removal of the heat source. Natural convection may occur until a temperature is reached which may facilitate the optional annealing process.

During sintering, a volume reduction typically occurs such that the sintered ceramic body may comprise a volume that is about one third that of the volume of the starting powder mixture when disposed in the tool set of the sintering apparatus.

The order of application of pressure and temperature in one embodiment may vary according to the present disclosure, which means that it is possible to apply at first the indicated pressure and thereafter to apply heat to achieve the desired temperature. Moreover, in other embodiments it is also possible to apply at first the indicated heat to achieve the desired temperature and thereafter the indicated pressure. In a third embodiment according to the present disclosure, the temperature and the pressure may be applied simultaneously to the powder mixture to be sintered and raised until the indicated values are reached.

Inductive or radiant heating methods may also be used for heating the sintering apparatus and indirectly heating the powder mixture in the tool set.

In contrast to other sintering techniques, preparation of the sample prior to sintering, i.e., by cold pressing or forming a green body before sintering is not necessary, and the premixed powder is filled directly in the mold. This may provide for higher purity in the final, sintered ceramic body.

In further contrast to other sintering techniques, sintering aids are not required. Additionally, a high purity starting powder is desirable for optimal etch performance and low RF transmission loss. The lack of sintering aids and the use of high purity starting materials, from between 99.99% to more than 99.9999% purity, enables the fabrication of a high purity, sintered ceramic body which provides improved etch resistance for use as a ceramic sintered component in semiconductor etch chambers.

Accordingly, sintering under isothermal dwell time is typically applied for a time period of 0 minute to 1440 minutes, preferably between 0 minutes to 720 minutes, preferably between 0 minutes to 360 minutes, preferably between 0 to 240 minutes, preferably between 0 to 120 minutes, preferably between 0 to 60 minutes, preferably between 0 to 30 minutes, preferably between 0 to 20 minutes, preferably between 0 to 10 minutes, preferably between 0 to 5 minutes.

In one embodiment of the present invention, process step d) may further comprise a pre-sintering step with a specific heating ramp of from 0.1° C./min to 100° C./min, preferably 1° C./min to 50° C./min, more preferably 2 to 25° C./min until a specific pre-sintering time is reached.

In a further embodiment of the present invention, process step d) may further comprise a pre-sintering step with a specific pressure ramp of from 0.50 MPa/min to 30 MPa/min, preferably 0.75 MPa/min to 20 MPa/min, more preferably 1 to 10 MPa/min until a specific pre-sintering time is reached.

In another embodiment, process step d) may further comprise a pre-sintering step with the above-mentioned specific heating ramp and with the above-mentioned specific pressure ramp.

At the end of process step d), in an embodiment, the method may further comprise step e), cooling of the sintered ceramic body in accordance with a natural cooling of the process chamber (unforced cooling) under vacuum conditions as known to those skilled in the art. In a further embodiment in accordance with process step e), the sintered ceramic body may be cooled under convection with inert gas, for example, at 1 bar of argon or nitrogen. Other gas pressures of greater than or less than 1 bar may also be used. In a further embodiment, the sintered ceramic body is cooled under forced convective conditions in an oxygen environment. To initiate the cooling step, the power applied to the sintering apparatus is removed and the pressure applied to the sintered ceramic body is removed at the end of the sintering step d) and thereafter cooling occurs in accordance with step e).

Step f) of the method disclosed herein is optionally annealing the sintered ceramic body by applying heat to raise the temperature of the sintered ceramic body to reach an annealing temperature, performing annealing and step g) is lowering the temperature of the annealed sintered ceramic body. In optional step f), the resulting sintered ceramic body or component of steps d) or h) respectively may be subjected to an annealing procedure. In other instances, annealing may not be performed on the sintered ceramic body or component. Under other circumstances, annealing may be performed in a furnace external to the sintering apparatus, or within the sintering apparatus itself, without removal from the apparatus.

For the purpose of annealing in accordance with this disclosure, the sintered ceramic body may be removed from the sintering apparatus after cooling in accordance with process step e), and the process step of annealing may be conducted in a separate apparatus such as a furnace.

In some embodiments, for the purpose of annealing in accordance with this disclosure, the sintered ceramic body in step d) may subsequently be annealed while inside the sintering apparatus, without the requirement of removal from the sintering apparatus between the sintering step d) and optional annealing step f).

This annealing leads to a refinement of the chemical and physical properties of the sintered body. The step of annealing can be performed by conventional methods used for the annealing of glass, ceramics and metals, and the degree of refinement can be selected by the choice of annealing temperature and the duration of time that annealing is allowed to continue.

Usually, the optional step f) of annealing the sintered ceramic body is carried out at a temperature of from about 900 to about 1800° C., preferably from about 1250 to about 1700° C., and more preferably from about 1300 to about 1650° C.

The optional annealing step f) is intended to correct oxygen vacancies in the crystal structure back to stochiometric ratio. The step of annealing the zirconia toughened alumina usually requires 5 min to 24 hours, preferably 20 min to 20 hours, more preferably 60 min to 16 hours.

Usually, the optional process step f) of annealing the sintered ceramic body is carried out in an oxidizing atmosphere, whereby the annealing process may provide increased albedo, lowered stress providing improved mechanical handling and reduced porosity. The optional annealing step may be carried out in air.

After the optional process step f) of annealing the sintered ceramic body is performed, the temperature of the sintered, and in some instances, annealed sintered ceramic body is decreased to an ambient temperature in accordance with process step g) and the sintered and optionally annealed ceramic body is taken out of either the furnace in the instance that the annealing step is performed external to the sintering apparatus, or removed from the tool set in case the annealing step f) is carried out in the sintering apparatus.

Step h) of the method disclosed herein is optionally machining of the sintered ceramic body to create a ceramic sintered component and may be carried out according to known methods for machining of corrosion resistant components from the sintered ceramic body as disclosed herein, comprising zirconia toughened alumina. Corrosion resistant ceramic sintered components as required for semiconductor etch chambers may include RF or dielectric windows, nozzles or injectors, shower heads, (etch) chamber liners, mixing manifolds, wafer supports, electronic wafer chucks, and various rings such as focus rings and protective rings, among other components.

The sintered ceramic body/component has mechanical properties sufficient to allow fabrication of a large body size for use in plasma etching and deposition chambers. The components as disclosed herein may have a size of from 200 mm to 600 mm, preferably from 300 to 600 mm, preferably from 350 to 600 mm, preferably from 400 to 600 mm, more preferably from 450 to 600 mm, more preferably from 500 to 600 mm, more preferably 550 to 600 mm, each with regard to the longest extension of the sintered body.

The method as disclosed herein provides for an improved control over the maximum pore size, higher density, improved mechanical strength and thereby handleability of the corrosion resistant ceramic sintered component in particular for those ceramic bodies of dimensions greater than, for example, 200 mm across a maximum feature size, and the reduction of oxygen vacancies in the lattice of the corrosion resistant ceramic sintered component.

The embodiments of the sintered ceramic body as disclosed herein can be combined in any specific sintered ceramic body. Thus, two or more of the characteristics disclosed herein can be combined to describe the sintered ceramic body in more detail as, for example, outlined in the embodiments.

Also disclosed herein is a sintered ceramic body prepared by a method comprising the steps of: a) combining aluminum oxide powder and zirconium oxide powder to make a powder mixture, wherein the aluminum oxide powder and the zirconium oxide powder each has a total impurity content of less than 150 ppm; b) calcining the powder mixture by applying heat to raise the temperature of the powder mixture to a calcination temperature and maintaining the calcination temperature to perform calcination to form a calcined powder mixture; c) disposing the calcined powder mixture inside a volume defined by a tool set of a sintering apparatus and creating vacuum conditions inside the volume; d) applying pressure to the calcined powder mixture while heating to a sintering temperature and performing sintering to form the sintered ceramic body; and e) lowering the temperature of the sintered ceramic body.

### Examples

The following examples are included to more clearly demonstrate the overall nature of the disclosure. These examples are exemplary, not restrictive, of the disclosure.

The SPS tool used for each of the Examples below comprised a die comprising a sidewall comprising an inner wall and an outer wall, wherein the inner wall has a diameter that defines an inner volume capable of receiving at least one ceramic powder; and an upper punch and a lower punch operably coupled with the die, wherein each of the upper punch and the lower punch have an outer wall defining a diameter that is less than the diameter of the inner wall of the die thereby defining a gap between each of the upper punch and the lower punch and the inner wall of the die when at least one of the upper punch and the lower punch are moved within the inner volume of the die, wherein the gap could be from 10 μm to 100 μm wide.

Particle sizes for the starting powders, powder mixtures and calcined powder mixtures were measured using a Horiba model LA-960 Laser Scattering Particle Size Distribution Analyzer capable of measuring particle size from 10 nm to 5 mm. Specific surface area for the starting powders, powder mixtures and calcined powder mixtures was measured using a Horiba BET Surface Area Analyzer model SA-9601 capable of measuring across a specific surface area of 0.01 to 2000 m²/g with an accuracy of 10% and less for most samples. specific surface area (SSA) measurements were performed according to ASTM C1274.

### Example One: Wet Ball Milling

A zirconia powder having a specific surface area of from 6 to 8 m²/g, a d10 particle size of from 0.5 to 0.2 um, a d50 particle size of from 0.2 to 0.5 um, and a d90 particle size of from 1.2 to 3 um and a powder of alumina having a specific surface area of from 6 to 8 m²/g, a d10 particle size of from 0.05 to 0.15 um, a d50 particle size of from 0.2 to 0.5 um, a d90 particle size of from 0.4 to 1 um were weighed and combined to create a powder mixture in a molar ratio to form a zirconia toughened aluminum phase upon sintering, wherein the zirconia is present at from 8 to 20 vol. %. The zirconia powder contains ˜2 wt % hafnium in solid solution and stabilized with 3 mol % yttrium oxide. HfO₂ and Yttria are not considered impurities in zirconia as disclosed herein. Reporting limits to detect presence of lighter elements using ICPMS as disclosed herein are higher than reporting limits of heavier elements. In other words, heavier elements, such as from Sc and higher, in accordance with the tables herein, are detected with greater accuracy than those lighter elements, from for example Li to Ca. While these lighter elements, such as Si, Na, Ca and Mg, may be present in amounts less than the reporting limit or not detected, the amounts of these elements may be reported with accuracy at levels of about 14 ppm and greater. Si, Ca, Na and Mg were not detected using ICPMS as known to those skilled in the art in the zirconia and alumina powders and as such, the zirconia and alumina powders may comprise about 14 ppm and less of Si, Ca, Na and/or Mg, in the form of silica, calcia (CaO), Na₂O and magnesia. Excluding HfO₂, yttria and lighter elements as defined herein the zirconia powder had total impurities of about 20 ppm. The powder mixture is transferred to a plastic container for wet ball milling using high purity (>99.99%) alumina media at 75 to 80% loading relative to powder weight and ethanol as a solvent. Ball milling is performed for 20 hours and thereafter the ethanol was extracted from the powder mixture using a rotary evaporator. The dry powder mixture was screened to ˜100 um granules and calcined at 600° C. for 8 hours. After calcination the powder mixture is dry blended by tumbling and finally sieved to granulate the particles from 100-400 um. The physical and chemical properties are then measured from the powder at this state. The calcined powder mixture is sintered at a temperature of 1600° C., a pressure of 15 MPa for a duration of 60 minutes under vacuum in accordance with the method as disclosed herein.

The purity of the calcined powder is listed in the table below. The table comprises ICPMS data for three powder lots after calcination in PPM, wherein ND is not detected. Elements not listed in the table were below the detection limit of the method and equipment and, therefore, not included.

| | Lot | Lot | Lot |
|---|---|---|---|
| | 21228 | 21231 | 21235 |
| Zn 66 | ND | 0.05 | 0.06 |
| Ga 71 | 0.32 | 0.22 | 0.27 |
| As 75 | ND | ND | 0.38 |
| Sr | 0.10 | 0.16 | ND |
| 84/87/88 | | | |
| Mo 95 | 0.02 | 0.06 | ND |
| La | 0.05 | 0.37 | 0.39 |
| 138/139 | | | |
| Ce 140 | 0.07 | 0.34 | 0.16 |
| Sm 147 | ND | 0.01 | ND |
| Gd 157 | 0.01 | 0.01 | ND |
| Dy 163 | 0.01 | 0.02 | 0.02 |
| Ho 165 | 0.01 | 0.01 | ND |
| Er 166 | 0.04 | ND | 0.03 |
| Tm 169 | 0.02 | 0.04 | 0.05 |
| Yb 171,2,3 | 0.10 | 0.18 | 0.14 |
| Lu 175 | 0.01 | 0.00 | 0.03 |
| Ir 193 | 0.06 | 0.07 | 0.06 |
| Pb 208 | 0.07 | 0.11 | 0.10 |
| Total PPM | 0.89 | 1.63 | 1.67 |

The calcined powder mixture above was sintered at a temperature of 1450° C. at a pressure of 30 MPa for a duration of 30 minutes under vacuum in accordance with the method as disclosed herein. Densities for embodiments of the sintered ceramic body are reported in the table following. The theoretical density was calculated in accordance with the volumetric mixing rule as known to those skilled in the art. Properties measured for the sintered ceramic body in accordance with Example 1 are summarized as follows:

| Part | Powder | ZrO₂ | ZrO₂ | Density | Density |
|---|---|---|---|---|---|
| number | number | (Vol %) | (Mass %) | (g/cc) | (% TD) |
| 215W21B | 215W21P-1 | 8 | 11.8 | 4.125 | 99.4 |
| 214W21B | 214W21P-1 | 10 | 14.5 | 4.187 | 99.9 |
| 213W21B | 209W21P-1 | 12 | 17.3 | 4.236 | 100 |
| 225W21B | 222W21P-1 | 14 | 19.9 | 4.278 | 100 |
| 104W21C | 104W21P-1 | 16 | 22.6 | 4.309 | 99.8 |
| 175W21C-1 | 175W21P | 18 | 25.1 | 4.357 | 99.9 |
| 176W21C | 176W21P-1 | 20 | 27.7 | 4.403 | 100 |

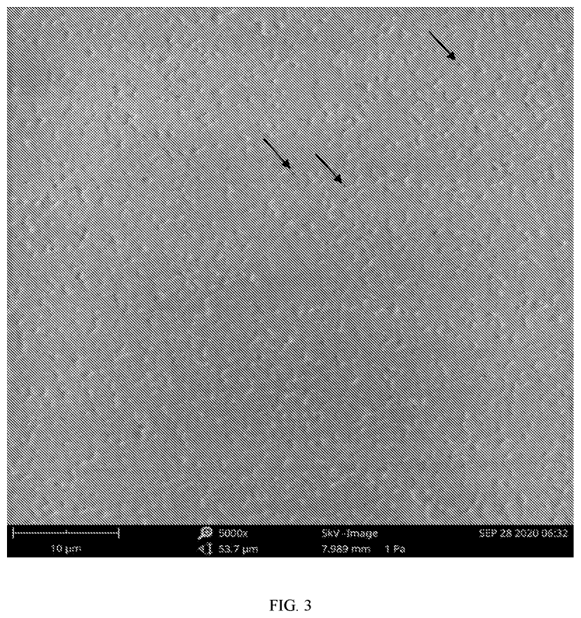

FIG. 3 is a SEM micrograph (5000×) of the surface of the sintered ceramic body made according to the present disclosure comprising 16 vol % ZrO₂. FIG. 3 shows a body of high density (˜99% density) having very low levels of porosity and, to the extent present, very small pore sizes.

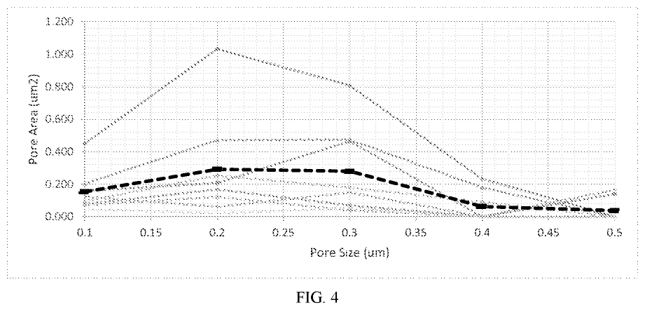

FIG. 4 is a plot of pore area versus pore size for 8 images taken from the surface of a sample with 16 vol % ZrO₂, wherein the dark line represents an average based upon the eight images analyzed. In FIG. 4, the total surface area comprised a maximum pore area of 1.03 μm² at 0.2 μm pore diameter. Measurements were performed across 8 images taken at 5000× magnification, each of a 53.7 μm×53.7 μm area for a total measurement area of about 2884 μm². A maximum pore size of 0.5 um was measured across the images taken thus the plot of FIG. 4 has an x axis limitation of 0.5 um.

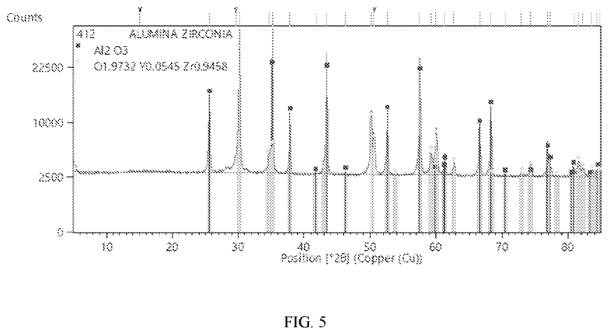

FIG. 5 is a graph illustrating the XRD pattern of a sintered ceramic body made according to the present disclosure comprising 15 vol % ZrO₂. The XRD pattern depicts two crystalline phases of alumina and zirconia with a very small amount of yttria (0.0545) due to its use as a stabilizer for zirconia. X ray diffraction was performed using a PANanlytical Aeris model XRD capable of crystalline phase identification to about +/−5%. The sintered ceramic bodies as disclosed herein may comprise a particle composite of the crystalline phases of zirconia and alumina in the amounts by volume as disclosed. The particle composite may comprise particles or regions of zirconia dispersed in a matrix of alumina wherein the particle composite comprises two separate crystalline phases and preferably the sintered ceramic body does not form a solid solution. Formation of a solid solution may degrade thermal conductivity and as such the sintered ceramic body preferably comprises separate crystalline phases of zirconia and alumina. While there may be no practical lower limit to the minimum amount of zirconia in the sintered ceramic body for thermal conductivity reasons, in order to provide high thermal conductivity on the order of that of alumina, a sintered ceramic body comprising a first crystalline phase of zirconia from about 10% by volume up to and including 25% by volume, with the balance comprising a second crystalline phase of alumina from about 75% by volume up to and including 90% by volume may be preferable. Sintered ceramic bodies having greater than about 25% to 30% by volume of zirconia may not provide sufficient thermal conductivity for use as for example components in semiconductor processing chambers for which high thermal conductivity is a requirement. As such, the sintered ceramic body comprises zirconia in amounts by volume of 16%. Further, use of MgO and/or silica as a sintering aid may result in a low thermal conductivity glassy phase present between grains, thus adversely affecting thermal conductivity as well as corrosion and erosion resistance.

Thermal conductivity measurements were performed in accordance with ASTM E1461-13 at ambient and at 200° C. temperature, and values of 27 and 14 W/m K were measured, respectively, for a sintered ceramic body as disclosed herein comprising about 16% by volume of zirconia and the balance alumina. The sintered ceramic bodies having compositions within the ranges as disclosed herein provide thermal conductivity sufficient for use in chamber components where high thermal conductivity is a requirement.

The following table lists material properties for a sintered ceramic body comprising about 16% ZrO₂ in an alumina matrix. Sintered objects formed from the sintered ceramic bodies as disclosed herein may have the properties of high strength and increased stiffness/young's modulus necessary for application of these objects to fabrication of objects having large dimension. The sintered ceramic body as disclosed herein may provide mechanical strength and stiffness/young's modulus in the range of that of alumina while providing the ability to tailor the coefficient of thermal expansion (CTE) across a temperature range from 25-200 to 25-1400° C., according to application specific requirements. Use of the ceramic sintered bodies as disclosed herein may significantly enhance strength and rigidity of articles of large dimension.

| | | | Aluminum | |
|---|---|---|---|---|
| Material Property | Test Method | Units | Zirconium Oxide | |
| Theoretical Density | as reported | g/cc | 4.3 | |
| Typical Measured | C 20-97 | g/cc | >4.19 | |
| Density | | | | |
| Largest Pore Size | SEM | μm | <5 | |
| (d90) | | | | |
| Bulk Purity | ICP-MS | % | >99.99 | |
| Water Absorption | | % | ~0 to | 0.8% |
| Grain Size-Average | Line intercept | μm | 1 to | 3 |

| | | | |
|---|---|---|---|
| Grain Size-Max | Line intercept | μm | 5 |
| 4pt Flexural Strength | ASTM C1161 | Mpa | 575 |
| (MOR) | | | |
| Young's Modulus | ASTM C1259-15 | Gpa | 395 |
| Vickers Hardness | ASTM C1327 | GPa | 20 |
| Fracture Toughness | Indention Method | MPa-m1/2 | 4.2 |
| Thermal | ASTM E1461-13 | W/(m-K) | 27 |
| Conductivity 20° C. | | | |
| Thermal | ASTM E1461-13 | W/(m-K) | 14 |
| Conductivity 200° C. | | | |
| C.T.E. (RT-200 C.) | ASTM E228-17 | × 10−6/° C. | 7.1 max |
| Volume Resistivity | ASTM D257 | ohm-cm | >1 E12 |
| 200° C. | | | |
| Dielectric Constant | ASTM D150 | — | 12 |
| @ 1 MHz | | | |
| Dielectric loss @ | ASTM D150 | — | 0.0007 |
| 1 MHz | | | |

The high densities, approaching theoretical and up to 100% of theoretical, and related low porosity of the ceramic sintered bodies as disclosed herein provide for a very low water absorption as indicated in the preceding table. The low water absorption characteristics of the ceramic sintered bodies as disclosed herein may enable formation of a very thin and uniform, corrosion resistant film. Thus, in embodiments disclosed herein is a sintered ceramic body comprising water in an amount of from 0 to 0.8%, preferably from 0 to 0.5%, preferably from 0 to 0.3%, preferably from 0.1 to 0.3%, preferably from 0 to 0.1% relative to the percent of theoretical density as disclosed herein.

A number of embodiments have been described as disclosed herein. Nevertheless, it will be understood that various modifications may be made without departing from the spirit and scope of the embodiments as disclosed herein. Accordingly, other embodiments are within the scope of the following claims.

1. A sintered ceramic body having at least one surface, the sintered ceramic body comprising: a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size d90 of from 0.1 to 5 μm as measured by SEM, wherein sintered ceramic body exhibits a coefficient of thermal expansion of from 6.899 to 9.630×10⁶/° C. across a temperature range of from 25 to 1400° C. as measured in accordance with ASTM E228-17, wherein the sintered ceramic body has a relative density greater than 98% and has a density variation of 2% or less across a greatest dimension, wherein the greatest dimension is from 200 to 625 mm, and wherein Si is either not present in the sintered ceramic body or it is present in the sintered ceramic body in an amount of 100 ppm or less.

2. (canceled)

3. (canceled)

4. (canceled)

5. The sintered ceramic body of claim 1 wherein Si, if present, is present at not more than 14 ppm.

6. The sintered ceramic body of claim 1 having a total impurity content of 50 ppm or less of trace elements Li, Na, Mg, K, Ca, B, P, Fe, Cu, Cr, Zn, In, Sn, and Sb (total) as determined by ICPMS.

7. (canceled)

8. The sintered ceramic body of claim 1, wherein the maximum pore size d90 is from 0.1 to 3 μm as measured by SEM.

9. (canceled)

10. (canceled)

11. The sintered ceramic body of claim 1 wherein the sintered ceramic body has an arithmetical mean height (Sa) in an unetched area of from 3 to 20 nm.

12. The sintered ceramic body of claim 1 having a maximum height, Sz, in an unetched area of from 0.05 to 1.5 um according to ISO standard 25178-2-2012, section 4.1.7.

13. (canceled)

14. The sintered ceramic body of claim 1 having a purity of 99.985% and higher.

15. The sintered ceramic body of claim 1 having a thermal conductivity at ambient temperature of about 27 W/m K as measured in accordance with ASTM E1461-13.

16. The sintered ceramic body of claim 1 having a thermal conductivity at 200° C. of about 14 W/m K as measured in accordance with ASTM E1461-13.

17. The sintered ceramic body of claim 1 wherein the second crystalline phase comprising ZrO₂ is present at from 14 vol. % to 18 vol. % and the coefficient of thermal expansion is from 7.520 to 9.558×10⁻⁶° C. across a temperature range of from 25 to 1400° C. as measured in accordance with ASTM E228-17.

18. (canceled)

19. A method of making a sintered ceramic body, the method comprising the steps of:
a. combining aluminum oxide powder and zirconium oxide powder to make a powder mixture, wherein the aluminum oxide powder and the zirconium oxide powder each has a total impurity content of less than 150 ppm;
b. calcining the powder mixture by applying heat to raise the temperature of the powder mixture to a calcination temperature of from 600° C. to 1400° C. and maintaining the calcination temperature for a period of from 4 to 12 hours to perform calcination to form a calcined powder mixture;
c. disposing the calcined powder mixture inside a volume defined by a tool set of a sintering apparatus and creating vacuum conditions inside the volume, wherein the tool set comprises a graphite die defining the volume, an inner wall, a first and second openings, and first and second punches operatively coupled with the die, wherein each of the first and second punches have an outer wall defining a diameter that is less than a diameter of the inner wall of the die thereby creating a gap between each of the first and second punches and the inner wall of the die when at least one of the first and second punches moves within the volume of the die, wherein the gap is from 10 μm to 100 μm wide;
d. applying a pressure of from 5 MPa to 100 MPa to the calcined powder mixture while heating to a sintering temperature of from 1000 to 1700° C. and performing sintering to form the sintered ceramic body; and
e. lowering the temperature of the sintered ceramic body, wherein the sintered ceramic body has at least one surface, the sintered ceramic body comprising: a first crystalline phase comprising Al₂O₃ and from 8 vol. % to 20 vol. % of a second crystalline phase comprising ZrO₂, wherein the first crystalline phase is a continuous matrix and the second crystalline phase is dispersed in the continuous matrix, wherein the sintered ceramic body has pores wherein the pores have a maximum pore size d90 of from 0.1 to 5 μm as measured by SEM, wherein sintered ceramic body exhibits a coefficient of thermal expansion of from 6.899 to 9.630×10⁶/° C. across a temperature range of from 25 to 1400° C. as measured in accordance with ASTM E228-17, wherein the sintered ceramic body has a relative density greater than 98% and has a density variation of 2% or less across a greatest dimension, wherein the greatest dimension is from 200 to 625 mm, and wherein Si is either not present in the sintered ceramic body or it is present in the sintered ceramic body in an amount of 100 ppm or less.

20. (canceled)

21. The method according to claim 19, further comprising the steps of:
f. annealing the sintered ceramic body by applying heat to raise the temperature of the sintered ceramic body to reach an annealing temperature, performing annealing; and
g. lowering the temperature of the annealed sintered ceramic body.

22. The method according to claim 19 further comprising the step of:
h. machining the sintered ceramic body to create a sintered ceramic component in the form of a dielectric window or RF window, a focus ring, a nozzle or a gas injector, a shower head, a gas distribution plate, an etch chamber liner, a plasma source adapter, a gas inlet adapter, a diffuser, an electronic wafer chuck, a chuck, a puck, a mixing manifold, an ion suppressor element, a faceplate, an isolator, a spacer, and/or a protective ring in etch chambers.

23. The method of claim 19 wherein the sintering temperature is from 1000 to 1300° C.

24. The method of claim 19 wherein from 5 to 59 MPa of pressure is applied to the calcined powder mixture while heating to the sintering temperature.

25. (canceled)

26. (canceled)

27. (canceled)
